(19) United States
(12) Patent Application Publication
(10) Pub. No.: US 2026/0003862 A1
(43) Pub. Date: Jan. 1, 2026

(54) DYNAMIC IDENTIFICATION OF KNOWLEDGE SETS FOR USE WITH ARTIFICIAL INTELLIGENCE ASSISTANTS

(71) Applicant: Tektronix, Inc., Beaverton, OR (US)

(72) Inventors: Dane Miller, Salt Lake City, UT (US); Keith D. Rule, Beaverton, OR (US); Abdul Bailey, Queen Creek, AZ (US)

(21) Appl. No.: 19/242,869

(22) Filed: Jun. 18, 2025

Related U.S. Application Data
(60) Provisional application No. 63/665,212, filed on Jun. 27, 2024.

(51) Int. Cl. G06F 16/245; G06F 16/22; G06F 16/248; G06F 21/62

(52) U.S. Cl. CPC G06F 16/245; G06F 16/2237; G06F 16/248; G06F 21/6218

(57) ABSTRACT

A test and measurement instrument includes one or more memories, a generative artificial intelligence (AI) model to access to the one or more memories, a display, user controls, and one or more processors configured to access an application programming interface (API) of an AI assistant for the generative AI model, receive one or more user inputs as a prompt through one or more of the API or a user interface, access a master vector database to retrieve a list of master candidates, compare the prompt to the list of master candidates to select ones of the master candidates, send the selected ones to a vector database, receive specific candidates from the vector database, send the prompt and the specific candidates to the generative AI model, receive a response, and display the response on the display.

### CROSS-REFERENCE TO RELATED APPLICATIONS

This disclosure is a non-provisional of and claims benefit from U.S. Provisional Application No. 63/665,212, titled “DYNAMIC IDENTIFICATION OF KNOWLEDGE SETS FOR USE WITH ARTIFICIAL INTELLIGENCE ASSISTANTS,” filed on Jun. 27, 2024, the disclosure of which is incorporated herein by reference in its entirety.

### TECHNICAL FIELD

This disclosure relates to artificial intelligence systems, and more particularly to artificial intelligence (AI) assistants.

### BACKGROUND

Presently, AI assistants and chatbots generally employ large language models (LLMs) or other forms of generative AI to function. Current LLMs are very resource intensive. In training, current LLMs require vast quantities of data to properly train. In runtime, current LLMs generally require vast cloud-based processing and memory resources, as well as power to operate these resources.

### BRIEF DESCRIPTION OF THE DRAWINGS

FIG. 1 shows an embodiment of a test and measurement instrument in an artificial intelligence system.

FIG. 2 shows a message flow diagram in an embodiment of an artificial intelligence system.

FIG. 3 shows a flowchart of an embodiment of a method to identify and select data sets in an artificial intelligence system.

### DETAILED DESCRIPTION

The embodiments herein generally use small, large language models (LLMs) in limited computing environments. The embodiments make these small, offline LLMs work as well or better than their huge, cloud-based counterparts. This requires carefully managing the information provided to the LLM.

As used here, the term “generative model” means generative models, such as LLMs, or any other type of model that can create responses for users in response to prompts. The term “knowledge set” means any component of information that can be loaded and used by the generative model. The term “prompt manager” means an AI assistant interface that receives inputs from a user and handles messaging between elements of the system, as well as managing the language of the prompt. The interface may be accessed through an assistant application programming interface (API).

The embodiments here define a method to separate core pieces of information/knowledge and define several possible methods for loading only information required to provide a response to the prompt. These methods, according to embodiments of the disclosure, generally will include ways to break knowledge into separate loadable pieces, and one or more methods for determining what bits of knowledge to load and when. The embodiments provide focused information without extraneous information, which reduces the chances of hallucinations.

The ability to control the loading of the smaller knowledge sets allows for a level of control not currently available. The knowledge sets and their associated information can be loaded as required so that export regulations such as the International Traffic in Arms Regulation (ITAR), security, where certain parties can access information, but others cannot, and other situations where leakage of privileged information must be avoided. The embodiments allow knowledge chunks to be loaded or metered based on having been purchased or subscribed by a particular user or organization, the security level of the user, such as a level of system administrator privileges, or the access to information to which the user is allowed. The embodiments result in the system having less information, but more focused data, which improves performance in a small compute environment.

Specific examples of these types of uses may include those in the test and measurement environment. For example, the control of the knowledge sets may allow users to isolate data sets to a specific instrument and/or model and license set, allowing an AI assistant to operate much more efficiently and limit irrelevant responses. They may provide the user with the ability to manage multiple instrument data sets simultaneously to troubleshoot and explain complicated multi-instrument set ups accurately.

In one embodiment, the system identifies and loads data sets based upon characteristics of the user. This may include the user security clearance, system access privileges, license status, the role of the user, location of the user such as the user's country. In one embodiment, the system may identify and load data sets based upon the factors external factors, such as the instrument being used, applicable regulations, applications being used, and licenses relevant to the applications.

AI Assistants need domain knowledge to be useful in most commercial settings. In the test and measurement instrumentation domain this knowledge may cover a wide range of topics. These may include, but are not limited to, the Programming API for specific instruments, general knowledge about signals (amplitude, data rate, rise/fall, . . . ), specific knowledge about protocols such as how to identify and setup inter-integrated circuit (I2C) signal decoding, as an example, and specific Troubleshooting knowledge, like what are the normal problems with I2C and how are they identified. Further examples include knowledge of specific multi-instrument setups, including Bode plots, compliance verification, and other examples, and knowledge of which functionalities are currently enabled on an instrument such as ITAR, licenses, whether the instrument has an arbitrary function generator, as examples.

The required knowledge in this domain could be thought of as a set of smaller pieces of knowledge. Being able to identify these smaller sets as well as the ability to store them as smaller, identifiable pieces of information allows an AI assistant to focus on only the knowledge sets required for a current request. This will limit the opportunity for hallucinations. As used here, a “hallucination” means an instance in which a generative AI model produces incorrect, inaccurate, or completely fabricated information. Generally, this situation results from the generative AI model misinterpreting inputs. One situation in which the hallucination may occur is when the model has access to too much information that it cannot absorb correctly. Limiting the amount of information, as well as the scope of the information having more focus, can alleviate this issue. Smaller knowledge sets may also speed up validation of candidate responses to further eliminate hallucinations.

In addition to the advantages discussed above, breaking the knowledge into smaller pieces and making it more manageable also allows these knowledge sets to be loaded dynamically as needed. This reduces the bandwidth issues within the system and makes the model nimbler and more responsive. The system can also track the use of the knowledge set which has uses in telemetry or metering. The metering of the knowledge sets may result in usage charges for billing. Even further, these smaller knowledge sets and the system that employs them may lead to knowledge sets to be packaged and sold as options or bundled with other instrument options, including conforming with ITAR. These smaller knowledge sets may allow knowledge sets to be updated with new data and redistributed individually. One should note that while the knowledge sets are smaller and therefore more manageable, overall access to the knowledge base itself has not changed. All the information remains available, but can be accessed in more manageable, faster ways.

Embodiments of the disclosure may be implemented in a variety of ways. The following are some example implementations, according to different embodiments, but embodiments of the disclosure are not necessarily limited to this list of possible implementations. In a first embodiment, a master knowledge dictionary maps requests to knowledge sets. This master database does not contain the response information, only a reference to the knowledge set(s) needed to respond to the answer. In this implementation, the mapping may allow the system to load referenced knowledge set for telemetry to know what knowledge is most used, as well as to meter access to the referenced knowledge sets, and to look up the responses in the specified knowledge sets.

Another embodiment may comprise a combined knowledge dataset with the knowledge to identify the source information by implementing a consolidated master knowledge base, but have it return both responses and the knowledge category. This may also allow for telemetry as above, to meter access to the referenced knowledge sets, to look up the responses in the specified knowledge sets, and for validation that the response to the request is from a referenced knowledge set, confirming that the response is not a hallucination.

Yet another embodiment may comprise a hybrid of the two. This embodiment may monitor the accuracy of the responses. Having both the combined knowledge base and the smaller, focused pieces of knowledge would allow the candidate user response to be validated so that the response contains knowledge expected to be in the answer.

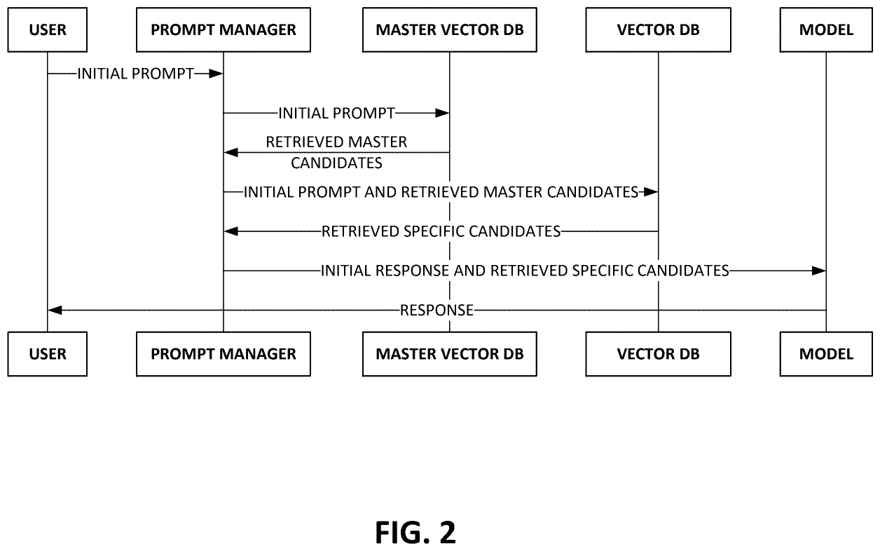

One specific use case of a retrieval based dynamic data set identification would be to pair it with another retrieval to optimize generation. In Retrieval Augmented Generation (RAG), a vector database is used to accept a prompt from the user and return candidates that include information about the topic of the prompt. As will be discussed below with regard to FIG. 2, these candidates get fed back into the model, along with the initial prompt, to improve the generative AI. Importantly, this technique can be used to provide data to a model inexpensively and without retraining. A dynamic data set identification system allows for many compartmentalized vector databases to be used within a single RAG system. In addition, the prompt and specific candidates, and/or the prompt and knowledge sets used in response to the prompt may be stored as a vector in the vector database for further reference for future prompts that may be similar.

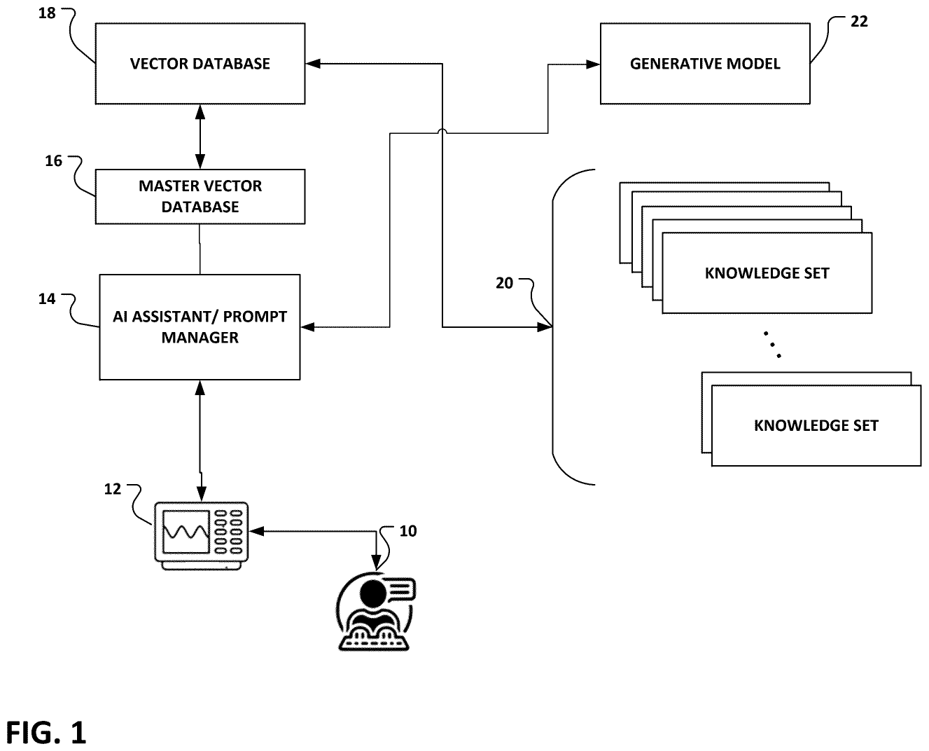

FIG. 1 shows an embodiment of an artificial intelligence system. While many of the examples discussed here involve a user in a test and measurement environment, the user 10 may work in any environment having a computing device with a generative AI component and some interface to that component. Additionally, the test and measurement system may comprise what most users would consider an instrument, such as an oscilloscope, multi-meter, etc. The test and measurement instrument 12 may comprise any of these types of instruments. The instrument will generally include one or more processors, a memory, a user interface for user inputs and controls, and a display.

As discussed above, the deployment of this system may comprise a small-scale environment, in which case all the elements of the system may reside on the instrument 12. Alternatively, only the interface may reside on the instrument 12, and the remaining elements of the system may reside on one or more separate computing devices, each with one or processors, etc. The examples above represent opposite ends of a spectrum of where the elements reside, and the system may reside in any point in between. For example, in one embodiment the AI assistant/prompt manager 14 resides on the instrument 12, with the generative model 22, the master vector database 16, and the vector database 18. The knowledge sets 20 may reside on the instrument 12 and distributed elsewhere. This example merely highlights how breaking the knowledge sets up into smaller pieces may alleviate bandwidth and speed issues if the entire knowledge base, made up of all the knowledge set, was to be loaded into the instrument 12 for each user query.

FIG. 2 provides a message flow diagram of one embodiment of how a prompt manager, which may be a part of, or comprise the entirety of the AI assistant 14, uses the initial user prompt to retrieve “master candidates,” which are themselves vector databases for specific purposes. The master vector database 16 comprises a database of databases, or vectors of vectors in the AI space. The master vector database only loads the retrieved master candidates, ensuring that the model receives only the most relevant information in the second phase of retrieval. A master candidate comprises a vector or other structure that contains multiple vectors of information, each vector within the master vector containing anywhere from one to many knowledge sets.

The master vector database may choose the master candidates by a variety of methods. If the system implements an “explicit configuration,” the system may query the configured instrument to determine its specifics such as its model, licenses, enabled functions, as well as its location as would be needed for ITAR, as examples. An “implicit configuration” would take a broader approach and not as specific as the explicit version. This may include loading master candidates depending on instruments connected to the current instrument without directly querying the connected instruments. This configuration may also take into account input/output usage such as that tracked through telemetry or load a “standard” workspace for the instrument.

Similarly, the selection may result from an “explicit context” such as loading specific master candidates from explicit user given context, such as prompt that asks, “How do I . . . on my Tektronix MSO6?” A more implicit context may cause the loading of approximately correct master candidates from implications including features and actions, such as loading any scope with an arbitrary waveform generator (AWG) when the user asks, “How do I turn on my AWG and set it up to generate a jittered clock to test the robustness of a digital input?” In one embodiment, creation of general instrument master candidates may prove useful, such as an oscilloscope candidate, an AWG candidate, etc.

FIG. 2 shows an embodiment of the “message” flow, where the term message applies to the requests and responses, between the various components of FIG. 1. The process begins with the user 10 entering an initial prompt on the instrument or other computing device 12, such as the example prompts mentioned above. Prompt manager 14 then indexes the prompt, identifying key words in the prompt, and sends the prompt to the master vector database 16. The master vector database 16, in whatever way it identifies the master candidates such as those discussed above, retrieves a set of master candidates. The master candidates comprise candidates made up of other candidates. The prompt manager 14 looks at the retrieved master candidates compared to the prompt and sends selected ones of the master candidates that relate to the prompt to the vector database 18. The vectors in the vector database 18 contain the list of knowledge sets 20. The selected ones of the candidates from the vector database 18, referred to here as “specific candidates” are then sent back to the prompt manager 14. The prompt manager 14 then sends the indexed prompt and the retrieved specific candidates to the generative model 22. The generative model 22 then loads the information from the specific candidates and uses that information combined with any other information that the model already has and produces a response to the user 10. The response passes back through the prompt manager which then displays the response on a display on the instrument 12.

For ease of discussion and understanding, the below example provides a more specific example in which the instrument 12 comprises an oscilloscope and the AI assistant 14 comprises an oscilloscope AI assistant. The prompt manager 14 gathers the user prompt, for example “How do I configure my scope to decode I2C serial communications on channel #1?” The prompt manager 14 then indexes the prompt and compares it to the master vector database 16. The master vector database compares the indexed prompt to the indices of the master candidates and returns the best master vector candidates. In this example, the particular Tektronix model being used by the user should be the most likely candidate. Depending on the use case and how the master vector database makes selections, the master vector database may also return other Tektronix oscilloscopes, or even a different company's most similar scope to the Tek scope being used.

The prompt manager 14 takes the indexed initial prompt and compares it to the specific candidates within each of the retrieved master candidates. As examples, the specific candidates could be Standard Commands for Programmable Instruments (SCPI) commands, user manual documentation, or even general waveform and electronics information. In this case, the most similar result may be documentation on the SCPI command “AFG:OUTPut:STATE” or the AFG page of the MSO64 user manual. This would be located within the MSO6 master candidate vector database 16. At this point, the initial prompt and the retrieved information get passed to the model 22. With knowledge of the AFG command set and the MSO64 user manual, the generative AI model should more accurately respond to the initial prompt.

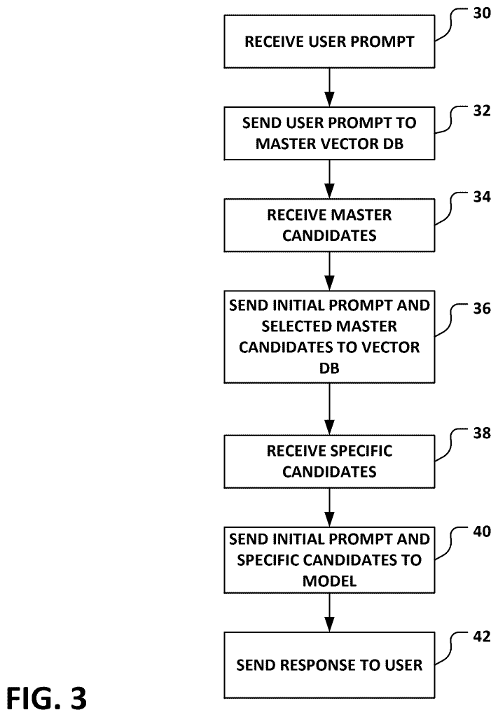

FIG. 3 shows a flowchart of the process from the view of the prompt manager/AI assistant 14. At 30, the prompt manager receives the prompt from the user. The prompt manager then sends the prompt to the master vector database at 32 and receives the set of master candidates in response at 34. The prompt manager then compares the master candidates to the indexed prompt and selects the best matching master candidates to send to the vector database at 36. The specific candidates from the vector database are received at 38. The prompt manager then sends the initial prompt and the specific candidates to the generative model then uses the uploaded knowledge sets from the specific candidates to generate a response to the user, which is sent to the user at 42.

In this manner, the system provides users a way to employ smaller generative AI instances and control the knowledge sets that are loaded as a portion of the overall knowledge base. This will allow better control of who has access to what data, allow the system to operate faster without having to load the entire knowledge base, and keep the data focused and relevant to prevent hallucinations.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a test and measurement instrument, comprising: one or more memories; a generative artificial intelligence (AI) model having access to the one or more memories; a display; user controls to allow a user to provide inputs; and one or more processors configured to execute that code that causes the one or more processors to: access an application programming interface (API) of an AI assistant for the generative AI model to allow the user to interact with the AI assistant; receive one or more user inputs through one or more of the API or a user interface, the user inputs comprising a prompt; access a master vector database using the prompt to retrieve a list of master candidates; compare the prompt to the list of master candidates to identify selected ones of the master candidates; send the selected ones of the master candidates to a vector database; receive specific candidates from the vector database; send the prompt and the specific candidates to a generative AI model; receive a response from the generative AI model; and display the response on the display.

Example 2 is the test and measurement instrument of Example 1, wherein the code that causes the one or more processors to access the master vector database comprises code that causes the one or more processors to access the master vector database based upon explicit information.

Example 3 is the test and measurement instrument of Example 2, wherein the explicit information comprises at least one of information from a query of the test and measurement instrument, information from the prompt, licenses associated with the test and measurement instrument, and user context information.

Example 4 is the test and measurement instrument of any of Examples 1 through, wherein the code that causes one or more processors to access the master vector database comprises code that causes the one or more processors to access the master vector database based upon implicit information.

Example 5 is the test and measurement instrument of Example 4, wherein the implicit information comprises at least one of instruments connected to the test and measurement instrument, input/output usages, and features of the test and measurement instrument.

Example 6 is the test and measurement instrument of any of Examples 1 through 5, wherein the code that causes the one or more processors to identify specific candidates comprises code that causes the one or more processors to identify specific candidates based upon characteristics of the user, the characteristics including one or more of user security clearance, user system access privileges, user license status, user role, and user location.

Example 7 is the test and measurement instrument of any of Examples 1 through 6, wherein the code that causes the one or more processors to identify specific candidates comprises code that causes the one or more processors to identify specific candidates based upon external factors, the external factors including one or more of an instrument being used, applicable regulations, software applications being used, and licenses relating to the software applications.

Example 8 is the test and measurement instrument of any of Examples 1 through 7, wherein at least one of the master vector database and the generative AI model reside locally to the test and measurement instrument.

Example 9 is the test and measurement instrument of any of Examples 1 through 8, wherein the one or more processors are further configured to identify and package knowledge sets for sale.

Example 10 is the test and measurement instrument of any of Examples 1 through 9, wherein the one or more processors are further configured to execute code to cause the one or more processors to meter usage of knowledge sets for billing.

Example 11 is the test and measurement instrument of any of Examples 1 through 10, wherein the one or more processors are further configured to execute code that causes the one or more processors to use the prompt and the specific candidates in retrieval augmented generation to update the model.

Example 12 is a method of identifying and selecting knowledge sets for use with a generative AI model, comprising: accessing an application programming interface (API) of an AI assistant for the generative AI model to allow a user to interact with the AI assistant; receiving one or more user inputs through one or more of the API or a user interface, the user inputs comprising a prompt; accessing a master vector database using the prompt to retrieve a list of master candidates; comparing the prompt to the list of master candidates to select ones of the master candidates; sending the select ones of the master candidates and the prompt to a vector database; receiving specific candidates from the vector database; sending the prompt and the specific candidates to a generative AI model; receiving a response from the generative AI model; and displaying the response on a display for the user.

Example 13 is the method of Example 12, wherein accessing the master vector database comprises accessing the master vector database based upon explicit information.

Example 14 is the method of Example 13, wherein the explicit information comprises at least one of information from a query of a test and measurement instrument, information from the prompt, licenses associated with the test and measurement instrument, and user context information.

Example 15 is the method of any of Examples 12 through 14, wherein accessing the master vector database comprises accessing the master vector database based upon implicit information.

Example 16 is the method of Example 15, wherein the implicit information comprises at least one of instruments connected to a test and measurement instrument, input/output usages, and features of the test and measurement instrument.

Example 17 is the method of any of Examples 12 through 16, identifying specific candidates comprises identifying specific candidates based upon characteristics of the user, the characteristics including one or more of user security clearance, user system access privileges, user license status, user role, and user location.

Example 18 is the method of any of Examples 12 through 17, wherein identifying specific candidates comprises identifying specific candidates based upon external factors, the external factors including one or more of an instrument being used, applicable regulations, software applications being used, and licenses relating to the software applications.

Example 19 is the method of any of Examples 12 through 18, further comprising identifying and packaging knowledge sets for sale.

Example 20 is the method of any of Examples 12 through 19, further comprising metering usage of knowledge sets for billing.

Example 21 is the method of any of Examples 12 through 20, further comprising using the prompt and the specific candidates in retrieval augmented generation to update the generative AI model.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

1. A test and measurement instrument, comprising:
one or more memories;
a generative artificial intelligence (AI) model having access to the one or more memories;
a display;
user controls to allow a user to provide inputs; and
one or more processors configured to execute that code that causes the one or more processors to:
access an application programming interface (API) of an AI assistant for the generative AI model to allow the user to interact with the AI assistant;
receive one or more user inputs through one or more of the API or a user interface, the user inputs comprising a prompt;
access a master vector database using the prompt to retrieve a list of master candidates;
compare the prompt to the list of master candidates to identify selected ones of the master candidates;
send the selected ones of the master candidates to a vector database;
receive specific candidates from the vector database;
send the prompt and the specific candidates to the generative AI model;
receive a response from the generative AI model; and
display the response on the display.

2. The test and measurement instrument as claimed in claim 1, wherein the code that causes the one or more processors to access the master vector database comprises code that causes the one or more processors to access the master vector database based upon explicit information.

3. The test and measurement instrument as claimed in claim 2, wherein the explicit information comprises at least one of information from a query of the test and measurement instrument, information from the prompt, licenses associated with the test and measurement instrument, and user context information.

4. The test and measurement instrument as claimed in claim 1, wherein the code that causes one or more processors to access the master vector database comprises code that causes the one or more processors to access the master vector database based upon implicit information.

5. The test and measurement instrument as claimed in claim 4, wherein the implicit information comprises at least one of instruments connected to the test and measurement instrument, input/output usages, and features of the test and measurement instrument.

6. The test and measurement instrument as claimed in claim 1, wherein the code that causes the one or more processors to identify specific candidates comprises code that causes the one or more processors to identify specific candidates based upon characteristics of the user, the characteristics including one or more of user security clearance, user system access privileges, user license status, user role, and user location.

7. The test and measurement instrument as claimed in claim 1, wherein the code that causes the one or more processors to identify specific candidates comprises code that causes the one or more processors to identify specific candidates based upon external factors, the external factors including one or more of an instrument being used, applicable regulations, software applications being used, and licenses relating to the software applications.

8. The test and measurement instrument as claimed in claim 1, wherein at least one of the master vector database and the generative AI model reside locally to the test and measurement instrument.

9. The test and measurement instrument as claimed in claim 1, wherein the one or more processors are further configured to identify and package knowledge sets for sale.

10. The test and measurement instrument as claimed in claim 1, wherein the one or more processors are further configured to execute code to cause the one or more processors to meter usage of knowledge sets for billing.

11. The test and measurement instrument as claimed in claim 1, wherein the one or more processors are further configured to execute code that causes the one or more processors to use the prompt and the specific candidates in retrieval augmented generation to update the model.

12. A method of identifying and selecting knowledge sets for use with a generative AI model, comprising:
accessing an application programming interface (API) of an AI assistant for the generative AI model to allow a user to interact with the AI assistant;
receiving one or more user inputs through one or more of the API or a user interface, the user inputs comprising a prompt;
accessing a master vector database using the prompt to retrieve a list of master candidates;
comparing the prompt to the list of master candidates to select ones of the master candidates;
sending the select ones of the master candidates and the prompt to a vector database;
receiving specific candidates from the vector database;
sending the prompt and the specific candidates to the generative AI model;
receiving a response from the generative AI model; and
displaying the response on a display for the user.

13. The method as claimed in claim 12, wherein accessing the master vector database comprises accessing the master vector database based upon explicit information.

14. The method as claimed in claim 13, wherein the explicit information comprises at least one of information from a query of a test and measurement instrument, information from the prompt, licenses associated with the test and measurement instrument, and user context information.

15. The method as claimed in claim 12, wherein accessing the master vector database comprises accessing the master vector database based upon implicit information.

16. The method as claimed in claim 15, wherein the implicit information comprises at least one of instruments connected to a test and measurement instrument, input/output usages, and features of the test and measurement instrument.

17. The method as claimed in claim 12, identifying specific candidates comprises identifying specific candidates based upon characteristics of the user, the characteristics including one or more of user security clearance, user system access privileges, user license status, user role, and user location.

18. The method as claimed in claim 12, wherein identifying specific candidates comprises identifying specific candidates based upon external factors, the external factors including one or more of an instrument being used, applicable regulations, software applications being used, and licenses relating to the software applications.

19. The method as claimed in claim 12, further comprising identifying and packaging knowledge sets for sale.

20. The method as claimed in claim 12, further comprising metering usage of knowledge sets for billing.

21. The method as claimed in claim 12, further comprising using the prompt and the specific candidates in retrieval augmented generation to update the generative AI model.
